(19) United States
(12) Patent Application Publication
(10) Pub. No.: US 2011/0228744 A1
(43) Pub. Date: Sep. 22, 2011

(54) Application Identification in Mobile Networks

(75) Inventors: Xue Jun Cai, Beijing (CN); Zhi Tao Wan, Beijing (CN)

(73) Assignee: NOKIA SIEMENS NETWORKS OY, Espoo (FI)

(21) Appl. No.: 13/062,859

(22) PCT Filed: Sep. 9, 2008
(86) PCT No.: PCT/EP2008/061919

§ 371 Date: May 26, 2011

(51) Int. Cl. H04W 36/00

(52) U.S. Cl. 370/331

(57) ABSTRACT

An apparatus includes a unit configured to perform an application identification on a traffic flow, and a unit configured to generate identification information as a result of the application identification. A unit is configured to store identification information, and a unit is configured to provide identification information during a connection handover procedure.

### FIELD OF THE INVENTION

The present invention relates to an apparatus, system and method for performing application identification in mobile networks.

### RELATED BACKGROUND ART

Application identification is used to determine the intrinsic protocol of traffic carried over the network. It is an important technology to provide informative characteristics of network traffic, which is indispensable under various aspects such as e.g. effective network planning and design, security policy such as legal monitoring and/or blocking, quality of service (QoS) enforcement such as traffic shaping and service differentiation, and designing a profitable billing and charging policy.

The design of a state-of-the-art communication network at present usually follows a layered model such as the OSI (open systems interconnection) and TCP/IP (transmission control protocol/internet protocol) reference models.

Specifically, the TCP/IP reference model as shown in FIG. 1 is usually adopted by most data networks. The TCP/IP reference model consists of five layers: Physical Layer, Data Link Layer, Network Layer, Transport Layer, and Application Layer.

The relay nodes such as e.g. an access gateway usually only involve the IP layer transfer and relay. The transport layer and application layer are transparent for them. That is, it is common that they do not know the content carried in the upper layers. However, as mentioned above, in some cases it is e.g. necessary to block a certain type of application so that these relay nodes need to find an efficient way to identify and determine the protocol type carried in the application layer.

At present, three types of application identification mechanisms are known and thus often adopted in the access routers: port based, payload based and behavior based.

Port based identification is the simplest and most traditional method which classifies the application protocol by port number. It identifies the application type from the port number carried in the header of the transport layer (TCP/UDP). For standard protocols, the correspondence between the port number and the protocol is defined by the IANA (Internet Assigned Numbers Authority), for example, HTTP (hypertext transfer protocol) typically uses port 80 while SMTP (simple mail transfer protocol) uses port 25. Although port based identification is highly efficient and easy to implement, it is very unreliable to identify the application protocol just based on the port number.

Payload based identification is an alternative to port number based classification which inspects the payload of the protocol carried in the traffic packets with deep packet inspection (DPI) technology, for example. This method is implemented by seeking deterministic character strings (a signature) in the payload part carried in the data packet (see, for example, Alfred V. Aho and Margaret J. Corasick: “Efficient string matching: An aid to bibliographic search”, Communications of the ACM 18(6), pages 333-340, 1975). For example “http/1.” corresponds to the application HTTP, and “0xe319010000” corresponds to “eDonkey” applications. In order to improve the matching accuracy, a more complex method using regular expression match can be used, as described by John E. Hoperoft and Jerey D. Ullman: “Introduction to Automata Theory, Languages, and Computation”, Addison Wesley, 1979. For example, the project of “Application Layer Packet Classifier for Linux” (http://17-filter.sourceforge.net) uses regular expression matching of the application layer data of a connection to determine what protocol is used. For example, to identify the HTTP protocol, the following regular expression is used: “http/(0\.9|1\.0|1\.1) [1-5][0-9][0-9]|post [\x09-\x0d-˜]* http/[01]\.[019]”.

Payload based identification usually provides more accurate results compared with other methods. However, at mean time it also introduces a higher system overhead than other methods.

Another important identification technology is behavior based identification. Unlike payload based identification, behavior based identification does not check the contents of the traffic, but instead identifies the application according to the observed behaviors or characterizations of received traffic such as the packet size, connection number, and etc.

For example, in document T. Karagiannis, K. Papagiannaki, and M Faloutsos: “BLINC: Multilevel Traffic classification in the Dark”, ACM SIGCOMM, 2005, it is proposed to use the behaviors exposed in three different levels to identify specific applications and protocols, that is, (i) the social, (ii) the functional and (iii) the application level.

Another common behavior based method is to use statistical properties to identify and classify the traffic in terms of application.

For example, in document Andrew W. Moore and Konstantina Papagiannaki: “Internet traffic classification using bayesian analysis techniques”, ACM SIGMETRICS, 2005, the authors propose to use supervised machine-learning (naïve Bayesian classifier) to identify internet network traffic.

Behavior based identification usually causes less performance overhead compared with payload based identification, since it does not check the content of the traffic.

However, the identification accuracy is generally lower than what can be obtained with content based identification. Further, it takes a longer time to identify the application than by payload and port based identification.

Usually it is the access router (AR) that is the enforcement point that performs policy/service control and QoS guarantee according to the type of the traffic. In mobile networks, a mobile node (MN) may need to switch between different access routers from time to time. Thus, in order to ensure the service continuity, it should have the capability to continually identify the application carried in the traffic of the mobile node, even when the mobile node moves among different networks.

As shown in FIG. 2, if the mobile node (mobile terminal) handovers to another network in the middle of a session with a correspondent node (CN), a problem may arise with regard to application identification.

Namely, the access router in the new network has to perform the identification for the traffic of the mobile node without related information from the time before the handover. For behavior-based identification mechanisms, it will take some time to accurately identify the application, because the access router needs to collect and observe statistical behavior information for the identification. Before the application or service can be identified, the access router cannot decide how to deal with the traffic flow and will block it until it is identified. Therefore, additional service disruption and latency is introduced due to the identification.

Furthermore, since the mobile node may move to a new network in the middle of a session, both the behavior and payload based identification mechanisms may not be able to identify the application correctly due to lack of the traffic information at the time before the handover of the MN. For example, in the above referenced document T. Karagiannis, K. Papagiannaki, and M Faloutsos: “BLINC: Multilevel Traffic classification in the Dark”, ACM SIGCOMM, 2005, it is proposed to identify the application by capturing the interactions between network hosts displaying diverse patterns across the various application types.

However, such interactions may only be observed in the beginning of the setup of the traffic flow. For payload based identification mechanisms, especially for DPI-based identification, the situation may be worse. The payload based identification usually needs to inspect the initial part in a traffic flow which is not available to the new access router after the handover.

For example, the regular expression “http/(0\.9|1\.0|1\.1) [1-5][0-9][0-9]|post [\x09-\x0d-˜]* http/[01]\.[019]” is used to identify the HTTP application by L7-filter. Therefore, these mechanisms can only identify the application by checking the first few packets in the beginning of the traffic flow (see e.g. Young J. Won, Byung-Chul Park, Hong-Taek Ju, Myung-Sup Kim and James W. Hong: “A Hybrid Approach for Accurate Application Traffic Identification”, Fourth IEEE/IFIP Workshop on End-to-End Monitoring Techniques and Services, 2006; and Andrew W. Moore and Konstantina Papagiannaki: “Toward the Accurate Identification of Networks Applications”, 6^{th} International Workshop on Passive and Active Network Measurement (PAM), 2006). If the mobile node moves into a new network in the middle of a HTTP flow, the access router in the new network cannot identify the HTTP application successfully, since it cannot match the regular expression in the flow anymore.

Another example is a FTP (file transfer protocol) application in which two traffic flows are setup between the client and server: one is used for the control messages and another one is used for data transfer. The port number of data flow is dynamically negotiated between the client and server via the control flow. Therefore, the data flow of FTP is usually identified by inspecting the message exchange in the control flow. However, after the handover, such messages are not available anymore to the new access router. Therefore, the FTP flow cannot be successfully identified.

In conclusion, the existing application identification mechanisms will introduce additional performance issues and may not work anymore in mobile networks.

As described above, until now all existing application identification mechanisms do not consider the case when a mobile node moves in the mobile networks. In these mechanisms, after moving into a new network in the middle of the application session the traffic flow carried by the mobile node has to be re-identified by the network all over again, which will introduce some disadvantages as described above.

Specifically, for the behavior based identification mechanisms it may take some time to identify the traffic flow after the handover which introduces additional service interruption in addition to the interruption caused by lower layer handover, e.g. layer 2 and layer 3 handover. Further, the identification may fail due to the lack of necessary context after the handover for both the behavior and payload based identification mechanisms. Moreover, an additional performance overhead is introduced.

### SUMMARY OF THE INVENTION

Therefore, it is an object of the present invention to overcome the problems described above.

In particular, with certain embodiments of the present invention a mechanism is proposed to improve the existing application identification mechanisms in mobile networks.

According to a first aspect of the present invention, there is provided an apparatus, comprising means configured to perform an application identification on a traffic flow; means configured to generate identification information as a result of the application identification; means configured to store identification information; and means configured to provide identification information during a connection handover procedure.

Certain modifications of the apparatus according to the first aspect may include the following.

The apparatus may be suitable for performing application identification in mobile networks.

The apparatus may further comprise means configured to provide mobile network access to a mobile node, wherein the traffic flow is a traffic flow of the mobile node and the connection handover procedure concerns a handover of connection access for the mobile node from mobile network access provided by the apparatus to mobile network access provided by another connection access providing entity.

The apparatus may further comprise means configured to receive identification information during a connection handover procedure; and means configured to provide identification information as the result of the application identification.

The apparatus may further comprise means configured to provide an access router functionality.

The apparatus may further comprise means configured to provide an access service network gateway functionality.

The apparatus may further comprise means configured to provide a gateway general packet radio service support node functionality.

The identification information may be provided by a message including a first type length value element relating to one traffic flow of a mobile node and defining an identified application type of the content carried in the traffic flow.

The message may include a second type length value element relating to the one traffic flow of a mobile node and defining an application name of the identified application type.

The identification information may comprise a 5-tuple including source internet protocol address, source port, destination internet protocol address, destination port, and transport protocol identifier, respectively with respect to the traffic flow.

The means configured to store identification information may be further configured to comprise a mobile node specific entry containing a mobile node identifier and an identification information list.

The mobile node identifier may comprise a 6-byte media access control address of the mobile node.

The identification information list may contain four fields comprising the 5-tuple in a first field representing an individual traffic flow, a string in a second field denoting a name of the application of the traffic flow represented by the 5-tuple, a Boolean variable in a third field indicating whether the identification information is transferred from another connection access providing entity, and a forth field for denoting a home address of the mobile node.

According to a second aspect of the present invention, there is provided an apparatus, comprising an application identifier configured to perform an application identification on a traffic flow; a generator processor configured to generate identification information as a result of the application identification; a memory configured to store identification information; and a controller configured to control provision of identification information during a connection handover procedure.

Certain modifications of the apparatus according to the second aspect may correspond to the modifications of the apparatus according to the first aspect set forth above.

According to a third aspect of the present invention, there is provided a system comprising a previous access router configured to provide connection access for a mobile node, to perform an application identification on a traffic flow of the mobile node, to generate identification information as a result of the application identification, and to store the identification information; and a new access router configured to provide connection access for the mobile node, wherein the previous access router and the new access router are configured to handover the connection access of the mobile node from the previous access router to the new access router, and to exchange the identification information during the handover.

According to a fourth aspect of the present invention, there is provided a method, comprising performing an application identification on a traffic flow; generating identification information as a result of the application identification; storing identification information; and providing identification information during a connection handover procedure.

Certain modifications of the method according to the fourth aspect may include the following.

The method may be capable of performing application identification in mobile networks.

The method may further comprise providing mobile network access to a mobile node, wherein the traffic flow is a traffic flow of the mobile node and the connection handover procedure concerns a handover of connection access for the mobile node from mobile network access provided by the apparatus to mobile network access provided by another connection access providing entity.

The method may further comprise receiving identification information during a connection handover procedure; and providing identification information as the result of the application identification.

The method may further comprise providing an access router functionality.

The method may further comprise providing an access service network gateway functionality.

The method may further comprise providing a gateway general packet radio service support node functionality.

The method may further comprise providing the identification information by a message including a first type length value element relating to one traffic flow of a mobile node and defining an identified application type of the content carried in the traffic flow.

The message may include a second type length value element relating to the one traffic flow of a mobile node and defining an application name of the identified application type.

The identification information may comprise a 5-tuple including source internet protocol address, source port, destination internet protocol address, destination port, and transport protocol identifier, respectively with respect to the traffic flow.

The storing of identification information may further comprise storing a mobile node specific entry containing a mobile node identifier and an identification information list.

The mobile node identifier may comprise a 6-byte media access control address of the mobile node.

The identification information list may contain four fields comprising the 5-tuple in a first field representing an individual traffic flow, a string in a second field denoting a name of the application of the traffic flow represented by the 5-tuple, a Boolean variable in a third field indicating whether the identification information is transferred from another connection access providing entity, and a forth field for denoting a home address of the mobile node.

According to a fifth aspect of the present invention, there is provided a method comprising providing connection access for a mobile node by a previous access router, performing an application identification on a traffic flow of the mobile node, generating identification information as a result of the application identification, storing the identification information, providing connection access for the mobile node by a new access router, handing over the connection access of the mobile node from the previous access router to the new access router, and exchanging the identification information during the handover by the previous access router to the new access router.

The method according to the fifth aspect of the present invention may be capable of performing application identification in mobile networks.

According to a sixth aspect of the present invention, there is provided a computer program product embodied as a computer readable medium which stores instructions comprising performing an application identification on a traffic flow; generating identification information as a result of the application identification; storing identification information; and providing identification information during a connection handover procedure.

Certain modifications of the computer program product according to the sixth aspect may correspond to the modifications of the method according to the fourth aspect set forth above.

### BRIEF DESCRIPTION OF THE DRAWINGS

Other objects, aspects, features and advantages of the present invention are apparent from the following description of the embodiments thereof which is to be taken in conjunction with the accompanying drawings, in which:

FIG. 1 shows the conventional TCP/IP network model;

FIG. 2 illustrates application identification in mobile networks according to the prior art;

FIG. 3 illustrates the concept of application identification according to certain embodiments of the present invention;

FIG. 4 illustrates the network architecture of mobile WiMAX;

FIG. 5 shows the application identification information transfer in WiMAX networks according to certain embodiments of the present invention; and

FIG. 6 illustrates the type length value (TLV) format in WiMAX networks.

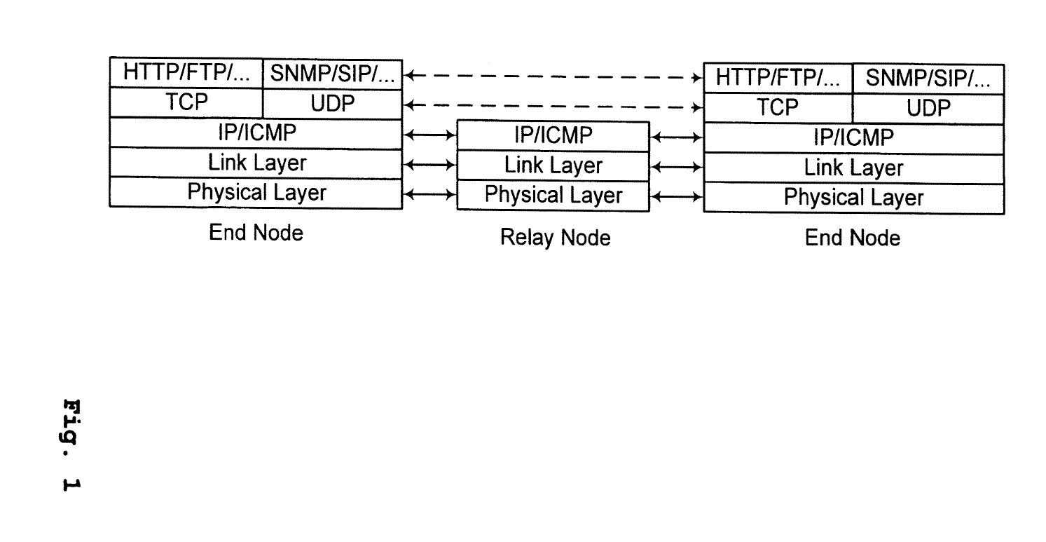

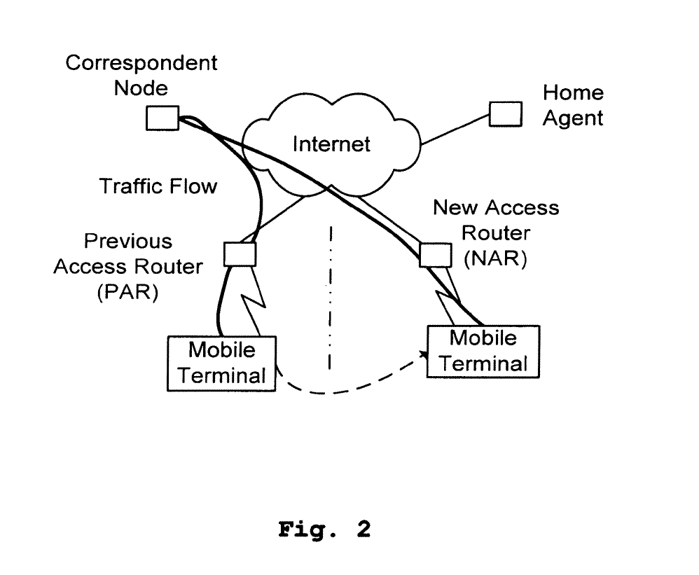

### DESCRIPTION OF THE PREFERRED EMBODIMENTS

In the following, description will be made to what are presently considered to be preferred embodiments of the present invention. It is to be understood, however, that the description is given by way of example only, and that the described embodiments are by no means to be understood as limiting the present invention thereto.

For example, embodiments of the present invention are presently considered to be particularly useful in WiMAX (worldwide interoperability for microwave access) networks, but other the present invention can also be applied to other mobile networks such as long term evolution (LTE) networks including system architecture evolution as defined by the 3^{rd} generation partnership project.

With certain embodiments of the present invention an apparatus, method and system are described to quickly identify and classify the protocol type of the application layer after the mobile node handover to other networks.

Specifically, as depicted in FIG. 3 showing an apparatus, method and system according to certain embodiments of the present invention, after a mobile node (MN) handovers to a new network the corresponding identification information of its traffic flows is transferred from a previous access router (PAR) to a new access router (NAR).

That is, the new access router (NAR) in the new network, i.e. after handover of a mobile node (MN), determines the application protocol of the traffic flows from/to the mobile node (MN) by exchanging information with the previous access router (PAR) in the old network, i.e. the access router of the mobile node (MN) before its handover.

This means that before the handover the previous access router (PAR) has identified the application of the traffic flow of the mobile node (MN). The identification is done by an application identifier function which can utilize either one of existing application identification technologies such as behavior or payload based or any other. An identification information table (IIT) is used to store the identification information from the application identifier for all connected mobile nodes.

According to certain embodiments of the present invention, this can be done by characterizing a traffic flow by a 5-tuple in the IP packet header, including source IP address, source port, destination IP address, destination port, and protocol ID such as TCP or UDP (user datagram protocol). For each traffic flow the name of the identified application is associated by the application identifier.

Certain embodiments of the present invention include the following two examples how to transfer the context from the previous access router (PAR) to the new access router (NAR).

A first one is that the context is directly exchanged between previous access router (PAR) and new access router (NAR). A second one is that the context is transferred by the previous access router (PAR) to another function entity such as an AAA (authentication, authorization and accounting) server from which the new access router (NAR) retrieves the context after the mobile node (MN) attaches to it. Therefore, the new access router (NAR) can easily identify the traffic after the handover based on such information and context.

Certain embodiments of the present invention include the use of the mobile IPv6 protocol where a new care-of-address (CoA) is obtained in the new network for the purpose of routing optimization. Thus, in the transferred identification context the traffic flow is classified by the 5-tuple which contains the source IP address, i.e. the home address (HoA) in the old network. Thus, the new access router (NAR) needs to correlate the CoA to the HoA when performing the identification after the mobile node (MN) attached to it. The correlation can be performed e.g. by intercepting the registration message, i.e. the binding update message sent from the mobile node (MN) to the home agent (HA). Another example would be to inspect the home address destination option included in the mobile IPv6 packet sent from the mobile node (MN).

In the following, implementation examples of certain embodiments of the present invention are described in detail, i.e. implementation examples for the identification of the application protocol in mobile networks.

Specifically, the implementation details for the application identification are described by using the example of networks according to the standard 802.16e of the IEEE (institute of electrical and electronics engineers). However, these details can be applied as well to other mobile networks such as LTE/SAE networks as mentioned above.

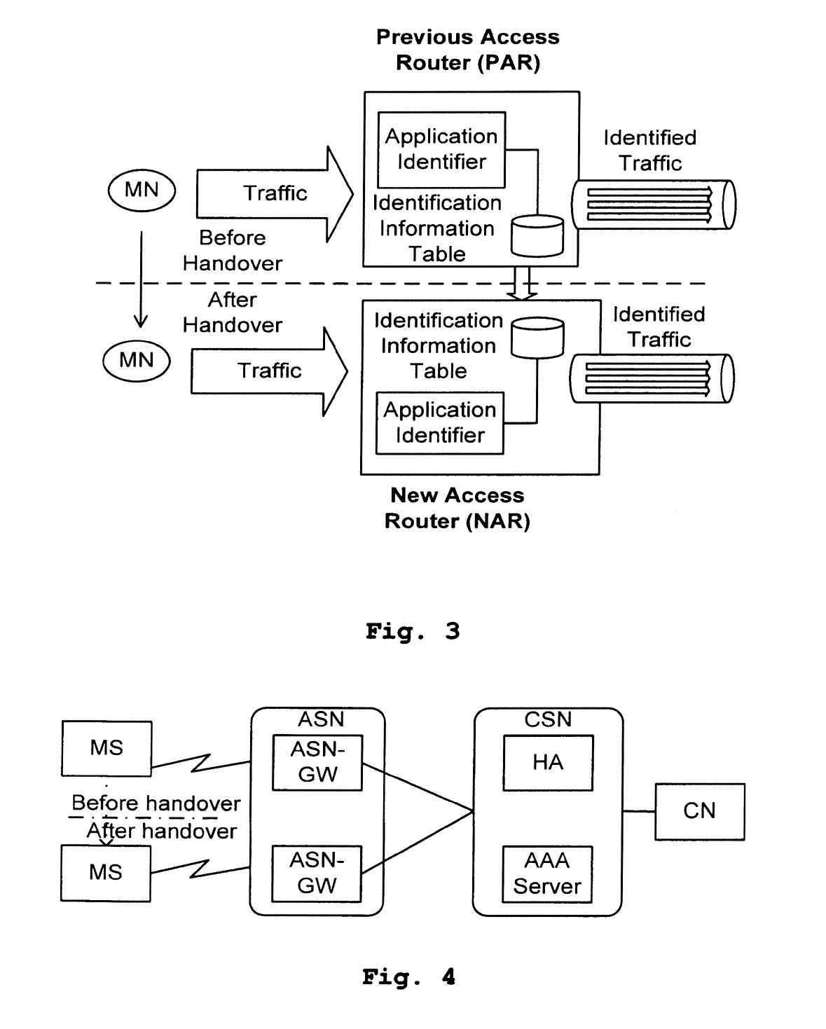

FIG. 4 depicts the network architecture of a 802.16 network as defined by the WiMAX forum. The mobile station (MS) is the generalized mobile equipment set providing connectivity between subscriber equipment and a base station (BS) and serves as an example of the above described mobile node (MN). The access service network (ASN) is defined as a complete set of network functions needed to provide radio access to a WiMAX subscriber. The connectivity service network (CSN) is defined as a set of network functions that provide IP connectivity services including AAA, HA etc. The correspondent node (CN) is the host that communicates with the mobile station (MS). The access service network gateway (ASN-GW) acts as access router which is the 1^{st}-hop router to the mobile station (MS). Therefore, according to certain embodiments of the present invention the application identification is done in the access service network gateway (ASN-GW). The access service network gateway (ASN-GW) connected to the mobile station (MS) before the handover is called the previous access router (PAR) while the access service network gateway (ASN-GW) connected after the handover is called the new access router (NAR). In addition, it is assumed that mobile IPv6 (MIPv6) as defined by document D. Johnson, C. Perkins, and J. Arkko: “Mobility Support in IPv6”, RFC 3775, June 2004, is used as the IP mobility management protocol by the WiMAX networks.

### Identification Information Table

As illustrated in FIG. 3, in each access service network gateway (ASN-GW), an identification information table (IIT) is maintained to contain the application identification information of all connected mobile stations (MS). The application identifier performs the actual application identification and is responsible for the maintenance and update of the identification information table (IIT). In the identification information table (IIT), for each mobile station (MS) there is an entry containing the traffic flows and identified application type. Each entry contains one mobile station identifier (MSID) and a list of identification information (IdentInfo).

Specifically, the mobile station identifier (MSID) identifies the mobile station (MS) and is set to the 6-byte media access control (MAC) address of the mobile station (MS). Furthermore, the identification information (IdentInfo) contains the following four fields:
FlowTuple: a 5-tuple (SrcAddr, DstAddr, SrcPort DesPort, Prot) to represent the individual traffic flow, indicating the source address, the destination address, the source port, the destination port, and the transport protocol identifier;
ProtoName: a string to denote the name of the application of the traffic flow represented by the FlowTuple;
Type: a Boolean variable to indicate whether the information is transferred from other networks (if the identification information is transferred from other access routers, the Type field is set to true, otherwise, the Type field is set to false); and
HomeAddr: denotes the home address of the mobile station (MS).

After the application identifier has identified the application type of a traffic flow, the identified application name and the 5-tuple of the flow are stored into the identification information table (IIT). If the mobile station (MS) is in its home network, the HomeAddr (home address) field may be empty. If the traffic flow is terminated, the corresponding item should be removed from the identification information table (IIT). However, if the mobile station as the mobile node (MN) disconnected from the access service network gateway (ASN-GW) as the access router (AR), the corresponding item should be kept from being deleted until a pre-defined timer expires in case the mobile station (MS) handovers to another access router (AR) such as an access service network gateway (ASN-GW).

### Identification Information Transfer

After the mobile station (MS) handovers to the new network, the application identification information stored in the access service network gateway (ASN-GW) which acts as PAR should be transferred to the access service network gateway (ASN-GW) which acts as NAR in order to assist it to do the application identification.

The implementation examples of certain embodiments of the present invention include the following examples to transfer such information from the PAR to the NAR.

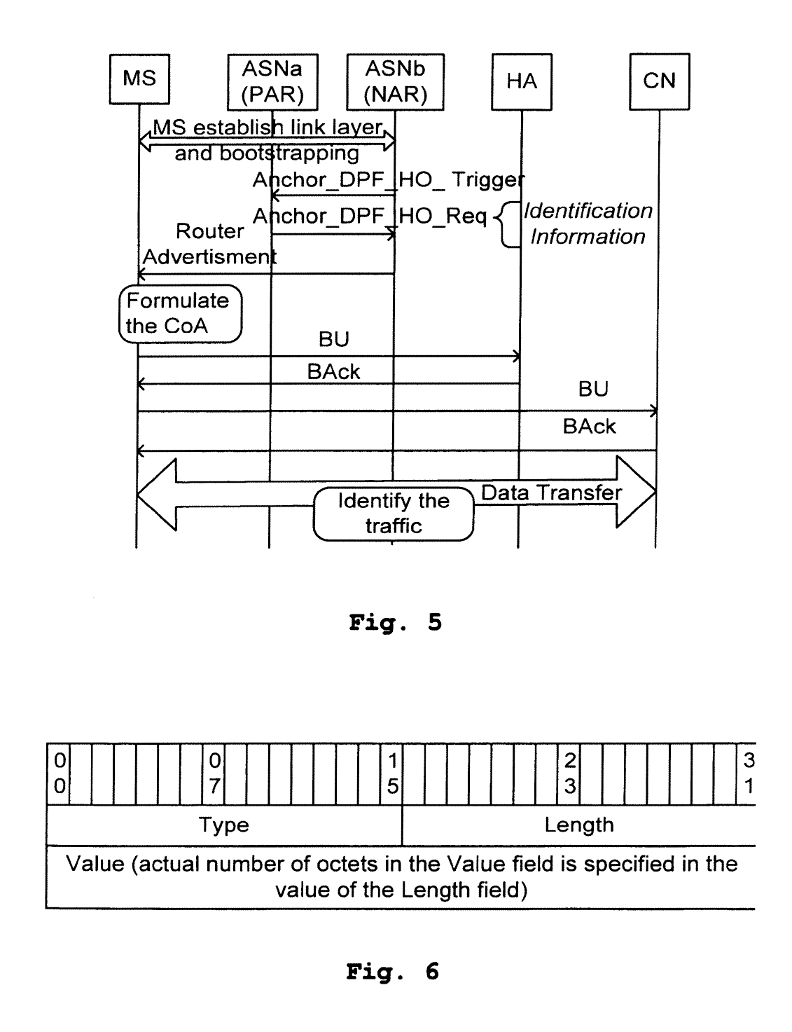

One way is to utilize the existing mechanism defined in WiMAX standard to exchange the information. FIG. 5 shows the general procedure of the MIPv6 inter access router handover defined in Stage 3 of WiMAX Forum Network Architecture (see WiMAX Forum Network Architecture: “Stage 3: Detailed Protocols and Procedures”, Release 1.0, 2007). As illustrated in FIG. 5, this procedure is extended here as follows to enable the transfer of the application identification information between access routers:
1) After the mobile station (MS) establishes link and IP layer connectivity, the NAR sends an Anchor_DPF_HO_Trigger message to the PAR to initiate the data path function (DPF) relocation.
2) The PAR sends an Anchor_DPF_HO_Req message to the NAR. The message contains mobility and other context information. According to the present example, the application identification information is also carried in this message and transferred between the NAR and PAR. Two new TLV (type length value), namely application identification information TLV and application name TLV, are defined to convey the related identification information of the mobile station (MS). The detailed format is presented in tables 1 and 2, respectively. For each traffic flow of the mobile station (MS), one application identification information TLV is constructed based on the corresponding entry in the identification information table (ITT). Then, this TLV is encoded into the Anchor MM Context TLV and sent to the NAR via the Anchor_DPF_HO_Req message. If the old network is not the home network of the mobile station (MS), the PAR should set the IP source address element in the application identification information TLV with the HomeAddr field in the entry. After receiving the message, the NAR extracts the TLV and stores it into the identification information table (ITT). A new entry for this mobile station (MS) is created in the identification information table (ITT), and for each application identification information TLV an IdentInfo item is created, in which the FlowTuple field is generated according to the first five elements in the TLV, and the ProtoName field is generated according to the application name TLV. The type field is set to true by the NAR.
3) The NAR sends a Router Advertisement message to the mobile station (MS) containing a new prefix used by the mobile station (MS) to formulate a new care-of-address (CoA).
4) After the mobile station (MS) acquired the new care-of-address (CoA), it sends a MIP6 Binding Update (BU) message to the home agent (HA) as per RFC 3375.
5) After receiving the Binding Update message, the home agent (HA) updates its binding cache with the new care-of-address (CoA) and responds to the mobile station (MS) with a Binding Acknowledgment (BAck) message indicating success.
6) If the Correspondent Node (CN) supports MIPv6 route optimization, the mobile station (MS) also sends a Binding Update message to the mobile station (MS) as the mobile node (MN).
7) After receiving the Binding Update message, the corresponding node (CN) updates its binding cache and responds to the mobile station (MS) with Binding Acknowledgment message.
8) Then the traffic is transferred between the mobile station (MS) as the mobile node (MN) and the home agent (HA) or corresponding node (CN) through the NAR.
9) The NAR identifies the application of the traffic flow from/to the mobile station (MS) with the identification information transfer from the PAR.

Accordingly, as explained above, two new TLV, namely application identification information and application name TLV, are defined by the instant implementation example to transfer the application identification information between access service network gateways (ASN-GW).

FIG. 6 illustrates the format of the TLV as defined in the WiMAX forum.

The type field defines the type of the data element. It is 2 bytes long. The length field defines the length of the value portion in octets. Thus, a TLV with no value portion has a length of zero. The value field itself can contain other TLV and such TLV are termed nested TLV.

Tables 1 and 2 depict the newly defined TLV application identification information TLV and application name TLV, respectively. The application name TLV is a sub-TLV of application identification information TLV. In addition, application identification information is a new defined optional sub-TLV of Anchor MM Context (anchor mobility management context) which is contained in the Anchor_DPF_Relocate_Req message. For more detailed information of Anchor MM Context and other sub-TLV, reference is made to WiMAX Forum Network Architecture: “Stage 3: Detailed Protocols and Procedures”, Release 1.0, 2007.

TABLE 1
application identification information TLV

| | |
|---|---|
| Type | |
| Length in | Variable |
| octets | |
| Value | Compound |
| Description | This TLV is used to carry the traffic flow |
| | and its identified application name |

| Elements | | |
|---|---|---|
| (Sub-TLV) | TLV Name | M/O² |
| | ¹IP Source Address (HoA of the MS) | M |
| | ¹IP Destination Address | M |
| | ¹Source Port | M |
| | ¹Destination Port | M |
| | ¹Protocol (TCP or UDP) | M |
| | Application Name | M |
| Parent TLV | Anchor MM Context | |

Note:
¹denotes the sub-TLV as already defined by WiMAX forum.
²refers to M—Mandatory, O—Optional.

TABLE 2
application name TLV

| | |
|---|---|
| Type | |
| Length in | 16 |
| octets | |
| Value | ASCII string |
| Description | Specifies the name of the identified |
| | application |
| Parent TLV | Application Identification Information |

Regarding the implementation examples of those certain embodiments of the present invention which include the use of mobile IPv6, a new care-of-address (CoA) is formulated, when the mobile station (MS) connects to the NAR. If the correspondent node (CN) also supports MIPv6, the communication between the mobile node (MN) and correspondent node (CN) does not require going through the home agent in the home network. When sending packets to the correspondent node (CN), the mobile station (MS) changes the source address field in the IPv6 header of the packet to its new acquired care-of-address (CoA) and inserts a home address destination option into the packet with its home address. If the correspondent node (CN) does not support MIPv6, the mobile station (MS) tunnels the packets through the home agent (see A. Conta, and S. Deering: “Generic Packet Tunnelling in IPv6 Specification”, RFC 2473, December 1998). The source address in the tunnel packet is the acquired care-of-address (CoA) as registered with the home agent. The destination address in the tunnel packet is the home agent's address. In both cases, the 5-tuple which is used to denote the traffic flow has changed. Therefore, when receiving the traffic from the mobile station (MS), the NAR not only checks the 5-tuple of the traffic flow, it also inspects the internals of the traffic flow. If route optimization is used, the NAR extracts the home address (HoA) from the home address destination option in the MIPv6 packets. Then the NAR looks up in the identification information table (IIT) the 5-tuple of the traffic flow where the home address (HoA) is used as the source address. If there is a matching entry, the NAR uses its ProtoName field to determine the application type. To speed up the identification, the NAR can update the corresponding entry in the identification information table (IIT) by replacing the SrcAddr in FlowTuple with the mobile node's care-of-address (CoA) and setting the HomeAddr field with the mobile node's home address (HoA). For the subsequent packets, the NAR does not need to inspect the home address option. If route optimization is not used, the access router (AR) checks the payload inside the tunnel from the mobile node (MN) to the home agent (HA) and looks up in the identification information table (ITT) with the 5-tuple in which the SrcAddr and DstAddr use the corresponding addresses extracted from the payload of the tunnel. The NAR uses the ProtoName field to determine the application type.

It is to be noted that whether to identify the application according to the transferred identification information may in any case be decided by the NAR. The NAR can still use its application identifier function to decide the application type of the traffic from/to the MS.

Certain embodiments of the present invention can provide the following advantages in terms of the performance, effectiveness and efficiency in comparison with the existing application identification mechanisms that do not use the transferred identification information.

The application identification procedure can be speeded up. As described above, the behavior based identification mechanism identifies the application according to the observed behaviors or characterizations of received traffic, such as the packet size, connection number, etc. Therefore, when the mobile node (MN) moves into the new network, the NAR cannot identify the application immediately and needs time to collect and observe the statistics before the traffic flow is identified. According to certain embodiments of the present invention, the NAR can identify the application immediately with identification information transferred from the PAR. By speeding up the identification, the service disruption and handover latency introduced by the identification process can be reduced compared with other mechanisms.

Further, payload based identification mechanisms sometimes cannot identify the traffic flow successfully after the handover. Payload based mechanisms identify the traffic flow by inspecting the payload of the application carried in the traffic with deep packet inspection (DPI) technology. These mechanisms identify the application by seeking deterministic character strings (signatures) or regular expressions in the payload. However, such signatures or regular expressions are usually in the fore part of the traffic flow. For example, the regular expression “http/(0\.9|1\.0|1\.1) [1-5][0-9][0-9]|post [\x09-\x0d-˜]* http/[01]\.[019]” can be used to identify the HTTP protocol. Therefore, these mechanisms can only identify the application by checking the packets since the beginning of the session. If the mobile node moves into the new network in the middle of a HTTP session, the NAR cannot identify the HTTP protocol, since it cannot match the regular expression. Therefore, according to certain embodiments of the present invention, the NAR can identify the application of the traffic flow that cannot be identified by other mechanisms after the handover.

Still further, the proposed identification mechanism introduces less performance overhead compared with behavior and payload based identification.

In addition, the proposed identification mechanism can enable service/policy control continuity between different policy enforcement points in the mobile networks, and, eventually, the mechanism is easy to be implemented.

As described above, certain embodiments of the present invention can be implemented by a message content exchange between access routers. Thus, in connection with a mobile node handover, a NAR and a PAR communicate with each other. Accordingly, these implementations concern access routers and security products that perform the service and application identification in mobile networks, such as a gateway GPRS (general packet radio service) support node (GGSN), access service network gateways (ASN-GW), session border controller, etc. For example, as also described above, certain embodiments of the present invention can be used to support the exchange and transfer of the application identification information between different access routers in WiMAX networks.

An implementation of certain embodiments of the present invention may be achieved by providing a computer program product embodied as a computer readable medium which stores instructions according to the above described embodiments.

Thus, described above is an apparatus, comprising means configured to perform an application identification on a traffic flow; means configured to generate identification information as a result of the application identification; means configured to store identification information; and means configured to provide identification information during a connection handover procedure. Further described above is a corresponding method, system and computer program product.

What is described above is what is presently considered to be preferred embodiments of the present invention. However, as is apparent to the skilled reader, these are provided for illustrative purposes only and are in no way intended that the present invention is restricted thereto. Rather, it is the intention that all variations and modifications be included which fall within the spirit and scope of the appended claims.

1-27. (canceled)

28. An apparatus, comprising:
means configured to perform an application identification on a traffic flow;
means configured to generate identification information as a result of the application identification;
means configured to store identification information; and
means configured to provide identification information during a connection handover procedure.

29. The apparatus according to claim 28, further comprising:
means configured to provide mobile network access to a mobile node, wherein
the traffic flow is a traffic flow of the mobile node and the connection handover procedure concerns a handover of connection access for the mobile node from mobile network access provided by the apparatus to mobile network access provided by another connection access providing entity.

30. The apparatus according to claim 28, further comprising:
means configured to receive identification information during a connection handover procedure; and
means configured to provide identification information as the result of the application identification.

31. The apparatus according to claim 28, wherein the identification information is provided by a message including a first type length value element relating to one traffic flow of a mobile node and defining an identified application type of the content carried in the traffic flow.

32. The apparatus according to claim 31, wherein the message includes a second type length value element relating to the one traffic flow of a mobile node and defining an application name of the identified application type.

33. The apparatus according to claim 28, wherein the identification information comprises a 5-tuple including source internet protocol address, source port, destination internet protocol address, destination port, and transport protocol identifier, respectively with respect to the traffic flow.

34. The apparatus according to claim 33, wherein the means configured to store identification information are further configured to comprise a mobile node specific entry containing a mobile node identifier and an identification information list.

35. The apparatus according to claim 34, wherein the mobile node identifier comprises a 6-byte media access control address of the mobile node.

36. The apparatus according to claim 34, wherein the identification information list contains four fields comprising the 5-tuple in a first field representing an individual traffic flow, a string in a second field denoting a name of the application of the traffic flow represented by the 5-tuple, a Boolean variable in a third field indicating whether the identification information is transferred from another connection access providing entity, and a fourth field for denoting a home address of the mobile node.

37. A system comprising:
a previous access router configured to provide connection access for a mobile node, to perform an application identification on a traffic flow of the mobile node, to generate identification information as a result of the application identification, and to store the identification information; and
a new access router configured to provide connection access for the mobile node, wherein
the previous access router and the new access router are configured to handover the connection access of the mobile node from the previous access router to the new access router, and to exchange the identification information during the handover.

38. A method, comprising:
performing an application identification on a traffic flow;
generating identification information as a result of the application identification;
storing identification information; and
providing identification information during a connection handover procedure.

39. The method according to claim 38, further comprising:
providing mobile network access to a mobile node, wherein
the traffic flow is a traffic flow of the mobile node and the connection handover procedure concerns a handover of connection access for the mobile node from mobile network access provided by the apparatus to mobile network access provided by another connection access providing entity.

40. The method according to claim 38, further comprising:
receiving identification information during a connection handover procedure; and
providing identification information as the result of the application identification.

41. The method according to claim 38, further comprising:
providing the identification information by a message including a first type length value element relating to one traffic flow of a mobile node and defining an identified application type of the content carried in the traffic flow.

42. The method according to claim 41, wherein the message includes a second type length value element relating to the one traffic flow of a mobile node and defining an application name of the identified application type.

43. The method according to claim 38, wherein the identification information comprises a 5-tuple including source internet protocol address, source port, destination internet protocol address, destination port, and transport protocol identifier, respectively with respect to the traffic flow.

44. The method according to claim 43, wherein storing identification information further comprises storing a mobile node specific entry containing a mobile node identifier and an identification information list.

45. The method according to claim 44, wherein the mobile node identifier comprises a 6-byte media access control address of the mobile node.

46. The method according to claim 44, wherein the identification information list contains four fields comprising the 5-tuple in a first field representing an individual traffic flow, a string in a second field denoting a name of the application of the traffic flow represented by the 5-tuple, a Boolean variable in a third field indicating whether the identification information is transferred from another connection access providing entity, and a fourth field for denoting a home address of the mobile node.

47. A method comprising:
providing connection access for a mobile node by a previous access router,
performing an application identification on a traffic flow of the mobile node,
generating identification information as a result of the application identification,
storing the identification information,
providing connection access for the mobile node by a new access router,
handing over the connection access of the mobile node from the previous access router to the new access router, and
exchanging the identification information during the handover by the previous access router to the new access router.

48. A computer program product embodied as a computer readable medium which stores instructions comprising:
performing an application identification on a traffic flow;
generating identification information as a result of the application identification;
storing identification information; and
providing identification information during a connection handover procedure.
